(19) United States
(12) Patent Application Publication
(10) Pub. No.: US 2018/0215044 A1
(43) Pub. Date: Aug. 2, 2018

(54) IMAGE PROCESSING DEVICE, ROBOT CONTROL DEVICE, AND ROBOT

(71) Applicant: Seiko Epson Corporation, Tokyo (JP)

(72) Inventor: Kenichi MARUYAMA, Tatsuno (JP)

(21) Appl. No.: 15/883,440

(22) Filed: Jan. 30, 2018

(30) Foreign Application Priority Data
Jan. 31, 2017 (JP) 2017-015147

(51) Int. Cl. B25J 9/16; G06K 9/00; G06T 7/70; G06K 9/20; G06K 9/62; B25J 13/08; B25J 9/00

(52) U.S. Cl. CPC B25J 9/1697; G06K 9/00664; B25J 9/1692; G06T 7/70; Y10S 901/47; G06K 9/6202; B25J 13/085; B25J 9/0096; Y10S 901/09; G06K 9/20

(57) ABSTRACT

An image processing device includes a processor that specifies a template, based on first distance information obtained by causing an imaging unit to image a calibration plate disposed at a first position inside a work region where a robot carries out work, and that performs matching between the specified template and an image obtained by causing the imaging unit to image an object disposed inside the work region.

### BACKGROUND

### 1. Technical Field

The present invention relates to an image processing device, a robot control device, and a robot.

### 2. Related Art

Template matching or a technique of controlling a robot using a result of the template matching has been researched and developed.

In this regard, a method is known as follows. Three-dimensional positions of an article are respectively detected from a pair of images obtained by imaging the article through stereoscopic vision using first and second imaging means. In the method, a two-dimensional appearance model having two-dimensional feature points of the article is set. The feature points respectively extracted from the pair of images are associated with each other via the two-dimensional appearance model. In this manner, the position of the article is detected (refer to JP-A-08-136220).

However, according to this method, in order to generate the two-dimensional appearance model, it is necessary to measure a distance from an imaging unit for imaging the article to the article. Therefore, in some cases, the method is less likely to reduce work to be carried out by a user.

### SUMMARY

An aspect of the invention is directed to an image processing device including a control unit that specifies a template, based on first distance information obtained by causing an imaging unit to image a calibration plate disposed at a first position inside a work region where a robot carries out work, and that performs matching between the specified template and an image obtained by causing the imaging unit to image an object disposed inside the work region.

According to this configuration, the image processing device specifies the template, based on the first distance information obtained by causing the imaging unit to image the calibration plate disposed at the first position inside the work region where the robot carries out the work, and performs the matching between the specified template and the image obtained by causing the imaging unit to image the object disposed inside the work region. In this manner, the image processing device can reduce the work to be carried out by a user in order to perform the matching between the template and the image obtained by imaging the object.

In another aspect of the invention, the image processing device may adopt a configuration in which the control unit specifies the template, based on the first distance information indicating a distance between the calibration plate and the imaging unit, which is a distance calculated based on the image obtained by causing the imaging unit to image the calibration plate during calibration.

According to this configuration, the image processing device specifies the template, based on the first distance information indicating the distance between the calibration plate and the imaging unit, which is the distance calculated based on the image obtained by causing the imaging unit to image the calibration plate during the calibration. In this manner, based on the first distance information, the image processing device can reduce the work to be carried out by the user in order to perform the matching between the template and the image obtained by imaging the object.

In another aspect of the invention, the image processing device may adopt a configuration in which the image captured by the imaging unit is a two-dimensional image.

According to this configuration, the image processing device specifies the template, based on the first distance information obtained by causing the imaging unit to image the calibration plate disposed at the first position inside the work region where the robot carries out the work, and performs the matching between the specified template and the two-dimensional image obtained by causing the imaging unit to image the object disposed inside the work region. In this manner, the image processing device can reduce the work to be carried out by the user in order to perform the matching between the template and the two-dimensional image obtained by imaging the object.

In another aspect of the invention, the image processing device may adopt a configuration in which when the first distance information is obtained, the calibration plate is disposed at the first position, and in which when the matching is performed, the object is disposed within a predetermined range including the first position inside the work region.

According to this configuration, when the first distance information is obtained, the calibration plate is disposed at the first position inside the work region. When the matching is performed between the template and the image obtained by causing the imaging unit to image the object disposed inside the work region, the object is disposed within the predetermined range including the first position inside the work region. In this manner, based on the calibration plate disposed at the first position inside the work region and the object disposed within the predetermined range including the first position inside the work region, the image processing device can reduce the work to be carried out by the user in order to perform the matching between the template and the image obtained by imaging the object.

In another aspect of the invention, the image processing device may adopt a configuration in which when the matching is performed, the object is disposed at the first position.

According to this configuration, when the matching is performed between the template and the image obtained by causing the imaging unit to image the object disposed inside the work region, the object is disposed at the first position inside the work region. In this manner, based on the calibration plate disposed at the first position inside the work region and the object disposed at the first position inside the work region, the image processing device can reduce the work to be carried out by the user in order to perform the matching between the template and the image obtained by imaging the object.

In another aspect of the invention, the image processing device may adopt a configuration in which the robot includes the imaging unit.

According to this configuration, the image processing device specifies the template, based on the first distance information obtained by causing the imaging unit to image the calibration plate disposed at the first position inside the work region where the robot including the imaging unit carries out the work, and performs the matching between the specified template and the image obtained by causing the imaging unit to image the object disposed inside the work region. In this manner, the image processing device can reduce the work to be carried out by the user in order to perform the matching between the template and the image obtained by causing the imaging unit included in the robot to image the object.

In another aspect of the invention, the image processing device may adopt a configuration in which imaging position information indicating an imaging position where the image is captured by the imaging unit is stored in advance in a robot control device which controls the robot.

According to this configuration, the image processing device specifies the template, based on the first distance information obtained by causing the imaging unit to image the calibration plate disposed at the first position inside the work region where the robot including the imaging unit carries out the work, and performs the matching between the specified template and the image obtained by causing the imaging unit to image the object disposed inside the work region at the imaging position indicated by the imaging position information. In this manner, the image processing device can reduce the work to be carried out by the user in order to perform the matching between the template and the image obtained by causing the imaging unit included in the robot to image the object at the imaging position indicated by the imaging position information.

In another aspect of the invention, the image processing device may adopt a configuration in which the control unit specifies the template, based on a distance range associated with the first distance information and the template, or specifies the template, based on a distance range associated with the first distance information and a scale factor of the template.

According to this configuration, the image processing device specifies the template, based on the distance range associated with the first distance information and the template, or specifies the template, based on the distance range associated with the first distance information and the scale factor of the template. In this manner, based on the distance range associated with the first distance information and the template, or based on the distance range associated with the first distance information and the scale factor of the template, the image processing device specifies the template. In this manner, based on the distance range associated with the first distance information and the template, or based on the distance range associated with the first distance information and the scale factor of the template, the image processing device can reduce the work to be carried out by the user in order to perform the matching between the template and the image obtained by imaging the object.

In another aspect of the invention, the image processing device may adopt a configuration in which the control unit divides one of the images into a plurality of regions, and specifies the template for each of the plurality of regions, based on the first distance information obtained for each of the plurality of divided regions.

According to this configuration, the image processing device divides one of the images obtained by causing the imaging unit to image the object disposed inside the work region into the plurality of regions, and specifies the template for each of the plurality of regions, based on the first distance information obtained for each of the plurality of divided regions. In this manner, based on the first distance information obtained for each of the plurality of regions into which one image obtained by causing the imaging unit to image the object disposed inside the work region is divided, the image processing device can reduce the work to be carried out by the user in order to perform the matching between the template and the image obtained by imaging the object.

Still another aspect of the invention is directed to a robot control device including the image processing device described above. The robot is operated based on a result of the matching performed by the image processing device.

According to this configuration, the robot control device operates the robot, based on the result of the matching performed by the image processing device. In this manner, the robot control device can reduce the work to be carried out by the user in order to cause the robot to carry out the work.

Still another aspect of the invention is directed to a robot controlled by the robot control device described above.

According to this configuration, the robot carries out the work for the object, based on the result of the matching carried out by the image processing device. In this manner, the robot can reduce the work to be carried out by the user in order to cause the robot to carry out the work.

Through the above-described configurations, the image processing device specifies the template, based on the first distance information obtained by causing the imaging unit to image the calibration plate disposed at the first position inside the work region where the robot carries out the work, and performs the matching between the specified template and the image obtained by causing the imaging unit to image the object disposed inside the work region. In this manner, the image processing device can reduce the work to be carried out by the user in order to perform the matching between the template and the image obtained by imaging the object.

The robot control device causes the robot to carry out the work for the object, based on the result of the matching performed by the image processing device. In this manner, the robot control device can reduce the work to be carried out the user in order to cause the robot to carry out the work.

The robot carries out the work for the object, based on the result of the matching performed by the image processing device. In this manner, the robot can reduce the work to be carried out the user in order to cause the robot to carry out the work.

### BRIEF DESCRIPTION OF THE DRAWINGS

The invention will be described with reference to the accompanying drawings, wherein like numbers reference like elements.

FIG. 1 illustrates an example of a configuration of a robot system according to an embodiment.

FIG. 2 illustrates an example of a hardware configuration of a robot control device.

FIG. 3 illustrates an example of a functional configuration of the robot control device.

FIG. 4 is a flowchart illustrating an example of a flow in a calibration process performed by the robot control device.

FIG. 5 illustrates an example of a calibration plate disposed at a first position inside a work region.

FIG. 6 is a flowchart illustrating a flow in a process in which the robot control device causes a robot to carry out predetermined work.

FIG. 7 illustrates an example of a plurality of templates stored in advance in a storage unit.

FIG. 8 illustrates an example of a relationship between a distance range including an entity of a first distance range and the first distance range.

FIG. 9 illustrates an example of a relationship between the distance range which does not include any portion of the first distance range and the first distance range.

FIG. 10 illustrates an example of a relationship between the distance range which includes a portion of the first distance range and the first distance range.

### DESCRIPTION OF EXEMPLARY EMBODIMENTS

### Embodiment

Hereinafter, an embodiment according to the invention will be described with reference to the drawings.

Configuration of Robot System

First, a configuration of a robot system 1 will be described.

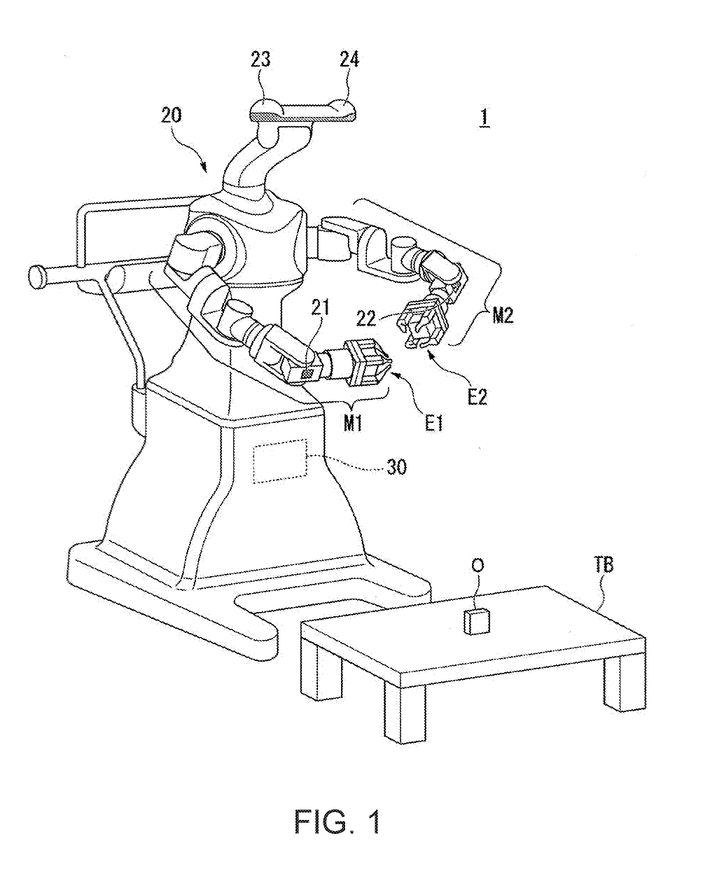

FIG. 1 illustrates an example of a configuration of the robot system 1 according to the embodiment. The robot system 1 includes a robot 20 having a robot control device 30 incorporated therein.

the robot 20 is a dual arm robot including a first arm, a second arm, a support base for supporting the first arm and the second arm, and the robot control device 30 disposed inside the support base. Instead of the dual arm robot, the robot 20 may be a multi-arm robot including three or more arms, or a single arm robot including one arm. The robot 20 may be another robot such as a scalar (horizontally articulated) robot, a Cartesian coordinate robot, and a cylindrical robot. For example, the Cartesian coordinate robot is a gantry robot.

The first arm includes a first end effector E1 and a first manipulator M1. Alternatively, the first arm may be configured to include the first manipulator M1 without including the first end effector E1. The first arm may be configured to include a force detection unit (for example, a force sensor or a torque sensor).

In this example, the first end effector E1 includes a claw portion capable of gripping an object. Instead of the end effector including the claw portion, the first end effector E1 may be the other end effector capable of lifting the object by using air suction, a magnetic force, or a jig.

The first end effector E1 is connected to the robot control device 30 via a cable so as to be capable of communicating therewith. In this manner, the first end effector E1 performs an operation based on a control signal acquired from the robot control device 30. For example, wired communication via the cable is performed in accordance with standards such as Ethernet (registered trademark) and a universal serial bus (USB). A configuration may be adopted in which the first end effector E1 is connected to the robot control device 30 by using wireless communication performed in accordance with communication standards such as Wi-Fi (registered trademark).

The first manipulator M1 includes seven joints and a first imaging unit 21. Each of the seven joints includes an actuator (not illustrated). That is, the first arm including the first manipulator M1 is a seven-axis vertically articulated arm. The first arm performs a free operation using seven axes by performing an operation in cooperation with the support base, the first end effector E1, the first manipulator M1, and the actuators of the seven joints. The first arm may be configured to perform a free operation using six axes or less, or may be configured to perform a free operation using eight axes or more.

In a case where the first arm performs the free operation using the seven axes, the first arm has the more applicable postures compared to a case where the first arm performs the free operation using the six axes or less. In this manner, the first arm performs a smooth operation, for example, and furthermore, the first arm can easily avoid interference with an object existing around the first arm. In a case where the first arm performs the free operation using the seven axes, the first arm is easily controlled owing to a decreased computational amount compared to a case where the first arm performs the free operation using the eight exes or more.

Each of the seven actuators included in the first manipulator M1 is connected to the robot control device 30 via a cable so as to be capable of communicating therewith. In this manner, the actuator operates the first manipulator M1, based on a control signal acquired from the robot control device 30. The wired communication via the cable is performed in accordance with standards such as Ethernet (registered trademark) and the USB, for example. A configuration may be adopted in which the seven actuators included in the first manipulator M1 are partially or entirely connected to the robot control device 30 by using the wireless communication performed in accordance with communication standards such as Wi-Fi (registered trademark).

For example, the first imaging unit 21 is a camera including a charge coupled device (CCD) or a complementary metal oxide semiconductor (CMOS) serving as an imaging element for converting collected light into an electric signal. In this example, the first imaging unit 21 is included in a portion of the first manipulator M1. Therefore, the first imaging unit 21 moves in accordance with the motion of the first arm. A range which can be imaged by the first imaging unit 21 varies in accordance with the motion of the first arm. The first imaging unit 21 captures a two-dimensional image of the range. The first imaging unit 21 may be configured to capture a still image of the range, or may be configured to capture a moving image of the range.

The first imaging unit 21 is connected to the robot control device 30 via the cable so as to be capable of communicating therewith. The wired communication via the cable is performed in accordance with standards such as Ethernet (registered trademark) and the USB, for example. A configuration may be adopted in which the first imaging unit 21 is connected to the robot control device 30 by using the wireless communication performed in accordance with communication standard such as Wi-Fi (registered trademark).

The second arm includes a second end effector E2 and a second manipulator M2. Alternatively, the second arm may be configured to include the second manipulator M2 without including the second end effector E2. The second arm may be configured to include a force detection unit (for example, a force sensor or a torque sensor).

In this example, the second end effector E2 includes a claw portion capable of gripping an object. Instead of the end effector including the claw portion, the second end effector E2 may be the other end effector capable of lifting the object by using air suction, a magnetic force, or a jig.

The second end effector E2 is connected to the robot control device 30 via the cable so as to be capable of communicating therewith. In this manner, the second end effector E2 performs an operation based on a control signal acquired from the robot control device 30. For example, the wired communication via the cable is performed in accordance with standards such as Ethernet (registered trademark) and the USB. A configuration may be adopted in which the second end effector E2 is connected to the robot control device 30 by using the wireless communication performed in accordance with communication standards such as Wi-Fi (registered trademark).

The second manipulator M2 includes seven joints and a second imaging unit 22. Each of the seven joints includes an actuator (not illustrated). That is, the second arm including the second manipulator M2 is a seven-axis vertically articulated arm. The second arm performs a free operation using seven axes by performing an operation in cooperation with the support base, the second end effector E2, the second manipulator M2, and the actuators of the seven joints. The second arm may be configured to perform a free operation using six axes or less, or may be configured to perform a free operation using eight axes or more.

In a case where the second arm performs the free operation using the seven axes, the second arm has the more applicable postures compared to a case where the second arm performs the free operation using the six axes or less. In this manner, the second arm performs a smooth operation, for example, and furthermore, the second arm can easily avoid interference with an object existing around the second arm. Ina case where the second arm performs the free operation using the seven axes, the second arm is easily controlled owing to a decreased computational amount compared to a case where the second arm performs the free operation using the eight exes or more.

Each of the seven actuators included in the second manipulator M2 is connected to the robot control device 30 via the cable so as to be capable of communicating therewith. In this manner, the actuator operates the second manipulator M2, based on a control signal acquired from the robot control device 30. The wired communication via the cable is performed in accordance with standards such as Ethernet (registered trademark) and the USB, for example. A configuration may be adopted in which the seven actuators included in the second manipulator M2 are partially or entirely connected to the robot control device 30 by using the wireless communication performed in accordance with communication standards such as Wi-Fi (registered trademark).

For example, the second imaging unit 22 is a camera including the CCD or the CMOS serving as an imaging element for converting collected light into an electric signal. In this example, the second imaging unit 22 is included in a portion of the second manipulator M2. Therefore, the second imaging unit 22 moves in accordance with the motion of the second arm. A range which can be imaged by the second imaging unit 22 varies in accordance with the motion of the second arm. The second imaging unit 22 captures a two-dimensional image of the range. The second imaging unit 22 may be configured to capture a still image of the range, or may be configured to capture a moving image of the range.

The second imaging unit 22 is connected to the robot control device 30 via the cable so as to be capable of communicating therewith. The wired communication via the cable is performed in accordance with standards such as Ethernet (registered trademark) and the USB, for example. A configuration may be adopted in which the second imaging unit 22 is connected to the robot control device 30 by using the wireless communication performed in accordance with communication standard such as Wi-Fi (registered trademark).

The robot 20 includes a third imaging unit 23 and a fourth imaging unit 24.

For example, the third imaging unit 23 is a camera including the CCD or the CMOS serving as an imaging element for converting collected light into an electric signal. In this example, the third imaging unit 23 is included in a portion where the range which can be imaged by the fourth imaging unit 24 can be imaged in a stereoscopic manner together with the fourth imaging unit 24. The third imaging unit 23 is connected to the robot control device 30 via the cable so as to be capable of communicating therewith. The wired communication via the cable is performed in accordance with standards such as Ethernet (registered trademark) and the USB, for example. A configuration may be adopted in which the third imaging unit 23 is connected to the robot control device 30 by using the wireless communication performed in accordance with communication standard such as Wi-Fi (registered trademark).

For example, the fourth imaging unit 24 is a camera including the CCD or the CMOS serving as an imaging element for converting collected light into an electric signal. In this example, the fourth imaging unit 24 is included in a portion where the range which can be imaged by the third imaging unit 23 can be imaged in a stereoscopic manner together with the third imaging unit 23. The fourth imaging unit 24 is connected to the robot control device 30 via the cable so as to be capable of communicating therewith. The wired communication via the cable is performed in accordance with standards such as Ethernet (registered trademark) and the USB, for example. A configuration may be adopted in which the fourth imaging unit 24 is connected to the robot control device 30 by using the wireless communication performed in accordance with communication standard such as Wi-Fi (registered trademark).

In this example, each functional unit of the above-described robot 20 acquires a control signal from the robot control device 30 incorporated in the robot 20. Each functional unit performs an operation based on the acquired control signal. The robot 20 may be configured to be controlled by the externally installed robot control device 30, instead of the configuration in which the robot 20 has the robot control device 30 incorporated therein. In this case, the robot 20 and the robot control device 30 configure a robot system. The robot 20 may be configured not to partially or entirely include the first imaging unit 21, the second imaging unit 22, the third imaging unit 23, and the fourth imaging unit 24.

In this example, the robot control device 30 is a controller which controls (operates) the robot 20. For example, the robot control device 30 generates a control signal based on an operation program stored in advance. The robot control device 30 outputs the generated control signal to the robot 20, and causes the robot 20 to carry out predetermined work.

### Outline of Predetermined Work Carried Out by Robot

Hereinafter, the predetermined work to be carried out by the robot 20 will be described.

The robot 20 partially or entirely causes the first imaging unit 21 to the fourth imaging unit 24 to image an object O disposed inside a work region of the robot 20. Hereinafter, as an example, a case where the robot 20 causes the first imaging unit 21 to image the object O will be described. The robot 20 may be configured to cause an imaging unit separate from the robot 20 to image the object O. In this case, the robot system 1 includes the imaging unit. The imaging unit is installed at a position where the object O can be imaged.

In this example, the work region where the robot 20 carries out the predetermined work is a region where a first region and a second region overlap each other. For example, the first region is a region where the center of gravity of the first end effector E1 is movable. For example, the second region is a region where the center of gravity of the second end effector E2 is movable. The work region where the robot 20 carries out the predetermined work may be any one of the first region and the second region. The first region may be the other region associated with the first end effector E1 such as a region where at least a portion of the first end effector E1 is movable. The second region may be the other region associated with the second end effector E2 such as a region where at least a portion of the second end effector E2 is movable.

For example, the object O is an industrial component or member such as a plate, a screw, and a bolt to be assembled into a product. In FIG. 1, in order to simplify the drawing, the object O is represented as a rectangular parallelepiped shaped object having a size which can be gripped by at least either the first end effector E1 or the second end effector E2. In the example illustrated in FIG. 1, the object O is disposed on an upper surface of a work table TB which is entirely included in the work region. For example, the work table TB is a base such as a table. The object O may be other objects such as daily necessities and living bodies, instead of the industrial component and member. A shape of the object O may be other shapes instead of the rectangular parallelepiped shape. The work table TB may be other objects on which the object O can be placed such as a floor surface and a shelf instead of the table.

The robot 20 grips the object O, based on an image obtained by causing the first imaging unit 21 to image the object O, and carries outwork for supplying the gripped object O to a predetermined material supply region (not illustrated) as the predetermined work. Alternatively, as the predetermined work, the robot 20 may be configured to carry out the other work for the object O, based on the image.

Outline of Process in which Robot Control Device Causes Robot to Carry Out Predetermined Work

Hereinafter, an outline of a process in which the robot control device 30 causes the robot 20 to carry out the predetermined work will be described.

The robot control device 30 performs calibration using a calibration plate before causing the robot 20 to carry out the predetermined work. The calibration is performed in order to calibrate an external parameter and an internal parameter of the first imaging unit 21. Specifically, the calibration is performed in order to associate a position on the image captured by the first imaging unit 21 and a position in a robot coordinate system RC with each other. That is, when causing the first imaging unit 21 to perform imaging, the robot control device 30 causes the first imaging unit 21 to perform the imaging inside a region whose parameter is adjusted by performing the calibration. A method by which the robot control device 30 performs the calibration may be a known method, or a method to be developed from now on. When the robot control device 30 performs the calibration, the calibration plate is disposed at a first position inside the work region. In this example, the first position is a predetermined position inside the work region of the robot 20, and is a position where the object O is disposed for the predetermined work. That is, in this example, the first position is a predetermined position inside an upper surface of the work table TB. When the robot 20 carries out the predetermined work, the object O may be configured to be disposed within a predetermined range including the first position inside the work region. For example, the predetermined range is a circular range having a predetermined radius around the first position. Alternatively, the predetermined range may be other ranges associated with the first position. Hereinafter, as an example, a case will be described where the object O is disposed at the first position when the robot 20 carries out the predetermined work.

The robot control device 30 operates the robot 20 so that a position and a posture of the first imaging unit 21 coincide with a predetermined imaging position and imaging posture. In a case where the position and the posture of the first imaging unit 21 coincide with the imaging position and the imaging posture, an imaging range which can be imaged by the first imaging unit 21 includes at least the upper surface of the work table TB.

Here, the robot control device 30 includes an image processing device 40 (to be described later) which is not illustrated in FIG. 1. The image processing device 40 controls the first imaging unit 21, and images the calibration plate disposed at the first position inside the work region. The image processing device 40 associates the position on the image captured by the first imaging unit 21 and the position in the robot coordinate system RC with each other, based on the image obtained by imaging the calibration plate. In this case, the image processing device 40 calculates a first distance representing a distance between the first imaging unit 21 and the calibration plate, and associates these positions with each other, based on the calculated first distance. The image processing device 40 specifies one or more templates from a plurality of templates, based on the calculated first distance.

The template is an image used in order to specify the posture of the object O by using template matching, and is a two-dimensional image representing the object O. The template may be computer graphics (CG) representing the object O, or may be an image in which the object O is imaged. Hereinafter, a case where the template is the CG will be described. In each template, the posture of the object O and a distance range corresponding to the distance between the first imaging unit 21 and the object O are associated with each other. In a case where the posture associated with the template and the posture of the object O coincide with each other, the appearance of the object O represented by a certain template substantially coincides with the appearance of the object O on the image in which the object O is imaged in a state where the position and the posture of the first imaging unit 21 coincide with the imaging position and the imaging posture. Here, in this example, the term of “substantially coincide with each other” means that both of these coincide with each other while misalignment in a range of a few percent to ten-odd percent is allowed. A size of the object O represented by the template substantially coincides with a size of the object O on the image where the object O is imaged by the first imaging unit 21 in a case where the distance between the object O and the first imaging unit 21 in that state is included in the distance range associated with the template. Here, in this example, the term of “substantially coincide with each other” means that both of these coincide with each other while the misalignment in the range of a few percent to ten-odd percent is allowed.

The image processing device 40 specifies one or more templates associated with the distance range including the calculated first distance from among the plurality of templates. That is, the image processing device 40 specifies one or more templates from among the plurality of templates, based on the first distance information obtained by causing the first imaging unit 21 to image the calibration plate disposed at the first position inside the work region. In this manner, the image processing device 40 can shorten a time required for the process in which the image processing device 40 specifies the template which is most similar to the object O through the template matching.

The image processing device 40 performs the template matching between one or more specified templates and the image obtained by causing the first imaging unit 21 to image the object O disposed inside the work region, thereby specifying the posture of the object O. For example, the posture is represented by a direction in the robot coordinate system RC of each coordinate axis in a three-dimensional local coordinate system associated with the center of gravity of the object O. Alternatively, a configuration may be adopted in which the posture is represented by other directions associated with the object O. The robot coordinate system RC is the robot coordinate system of the robot 20. The image processing device 40 calculates the position of the object O, based on the image. For example, the position is represented by a position in the robot coordinate system RC of the origin in the three-dimensional local coordinate system. Alternatively, a configuration may be adopted in which the position of the object O is represented by other positions associated with the object O. The template matching is an example of matching.

The robot control device 30 operates the robot 20, based on a result of the template matching performed by the image processing device 40. That is, the robot control device 30 operates the robot 20, based on the position and the posture of the object O which are calculated by the image processing device 40. In this manner, the robot control device 30 causes the robot 20 to carry out the predetermined work. Here, in this example, information indicating a position of a material supply region (not illustrated) is stored in advance in the robot control device 30.

Hereinafter, a process performed by the image processing device 40 and a process performed by the robot control device 30 including the image processing device 40 will be described in detail.

Hardware Configuration of Robot Control Device

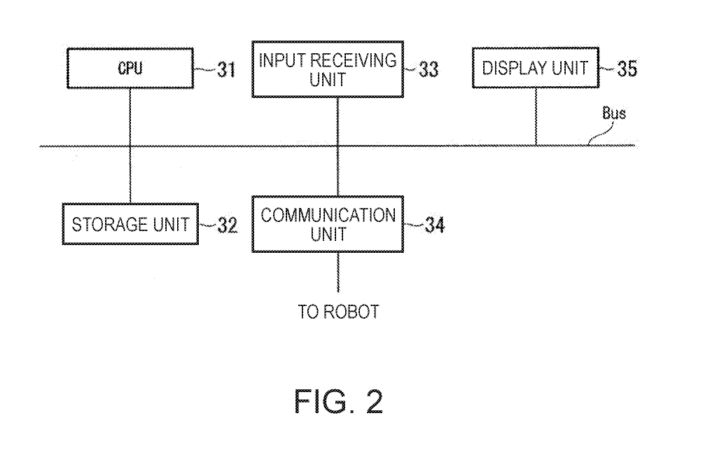

Hereinafter, referring to FIG. 2, a hardware configuration of the robot control device 30 will be described. FIG. 2 illustrates an example of the hardware configuration of the robot control device 30.

For example, the robot control device 30 includes a central processing unit (CPU) 31, a storage unit 32, an input receiving unit 33, a communication unit 34, and a display unit 35. These configuration elements are communicably connected to each other via a bus so as to be capable of communicating with each other. The robot control device 30 communicates with the robot 20 via the communication unit 34.

The CPU 31 executes various programs stored in the storage unit 32.

For example, the storage unit 32 includes a hard disk drive (HDD), a solid state drive (SSD), an electrically erasable programmable read-only memory (EEPROM), a read-only memory (ROM), and a random access memory (RAM). The storage unit 32 may be an external storage device connected by a digital input/output port such as the USB instead of the storage unit 32 incorporated in the robot control device 30. The storage unit 32 stores various information items processed by the robot control device 30 (including various information items processed by the image processing device 40), various programs including the above-described operation program, and various images.

For example, the input receiving unit 33 is a keyboard, a mouse, a touch pad, or other input devices. The input receiving unit 33 may be a touch panel configured to be integrated with the display unit 35.

For example, the communication unit 34 is configured to include a digital input/output port such as the USB, or an Ethernet (registered trademark) port.

For example, the display unit 35 is a liquid crystal display panel or an organic electroluminescence (EL) display panel.

### Functional Configuration of Robot Control Device

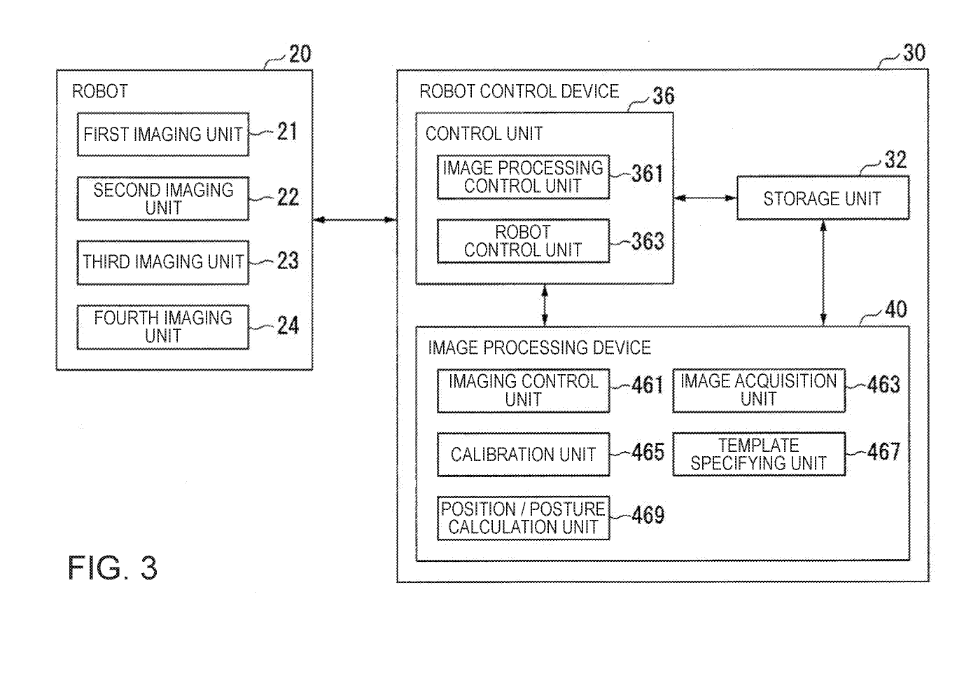

Hereinafter, referring to FIG. 3, a functional configuration of the robot control device 30 will be described. FIG. 3 illustrates an example of the functional configuration of the robot control device 30.

The robot control device 30 includes the storage unit 32, the control unit 36, and the image processing device 40.

The control unit 36 controls the overall robot control device 30. The control unit 36 includes an image processing control unit 361 and a robot control unit 363. For example, the functional units included in the control unit 36 are realized by the CPU 31 executing various programs stored in the storage unit 32. The functional units may be partially or entirely hardware functional units such as a large scale integration (LSI) and an application specific integrated circuit (ASIC).

The image processing control unit 361 controls the overall image processing device 40. That is, the image processing control unit 361 controls each functional unit included in the image processing device 40.

The robot control unit 363 operates the robot 20, based on an operation program stored in advance in the storage unit 32. The robot control unit 363 operates the robot 20, based on a result of the template matching performed by the image processing device 40.

The image processing device 40 includes an imaging control unit 461, an image acquisition unit 463, a calibration unit 465, a template specifying unit 467, and a position/posture calculation unit 469. For example, the functional units included in the image processing device 40 are realized by the CPU 31 executing various programs stored in the storage unit 32. The functional units may be partially or entirely hardware functional units such as the LSI and the ASIC.

The imaging control unit 461 causes the first imaging unit 21 to image a range which can be imaged by the first imaging unit 21. The imaging control unit 461 causes the second imaging unit 22 to image a range which can be imaged by the second imaging unit 22. The imaging control unit 461 causes the third imaging unit 23 to image a range which can be imaged by the third imaging unit 23. The imaging control unit 461 causes the fourth imaging unit 24 to image a range which can be imaged by the fourth imaging unit 24.

The image acquisition unit 463 acquires an image captured by the first imaging unit 21 from the first imaging unit 21. The image acquisition unit 463 acquires an image captured by the second imaging unit 22 from the second imaging unit 22. The image acquisition unit 463 acquires an image captured by the third imaging unit 23 from the third imaging unit 23. The image acquisition unit 463 acquires an image captured by the fourth imaging unit 24 from the fourth imaging unit 24.

The calibration unit 465 performs the calibration for associating the position on the image and the position in the robot coordinate system RC with each other, based on the image obtained by causing the first imaging unit 21 to image the calibration plate. In this case, the calibration unit 465 calculates a first distance which represents a distance between the first imaging unit 21 and the calibration plate, based on the image. The calibration unit 465 generates first distance information indicating the calculated first distance.

The template specifying unit 467 specifies one or more templates from among the plurality of templates stored in advance in the storage unit 32, based on the first distance information generated by the calibration unit 465.

The position/posture calculation unit 469 performs the template matching between one or more templates specified by the template specifying unit 467 and the image obtained by causing the first imaging unit 21 to image the object O. In this manner, the position/posture calculation unit 469 specifies the posture of the object O. The position/posture calculation unit 469 calculates the position of the object O, based on the image.

### Calibration Process Performed by Robot Control Device

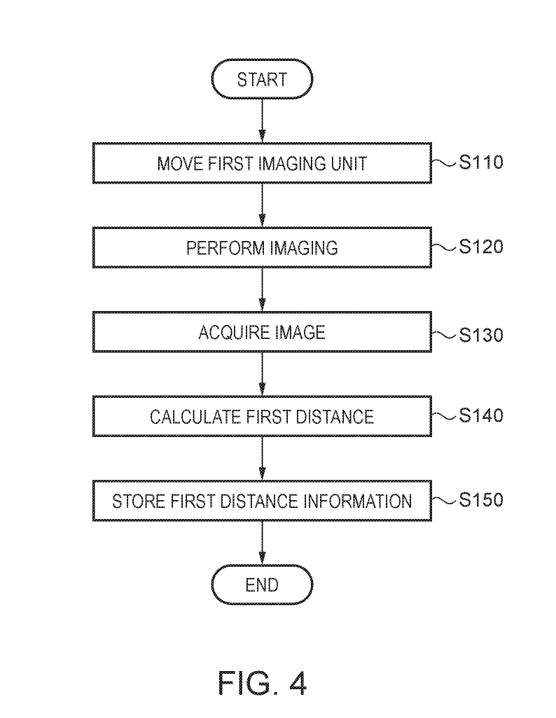

Hereinafter, referring to FIG. 4, a calibration process performed by the robot control device 30 will be described. The robot control device 30 performs the calibration process for associating the position on the image captured by the first imaging unit 21 and the position in the robot coordinate system RC with each other. FIG. 4 is a flowchart illustrating an example of a flow in the calibration process performed by the robot control device 30. In the following description, a process actively performed by each functional unit included in the image processing device 40 is performed by the image processing control unit 361 controlling each functional unit. Hereinafter, a case will be described where the calibration plate is previously disposed at the first position inside the work region.

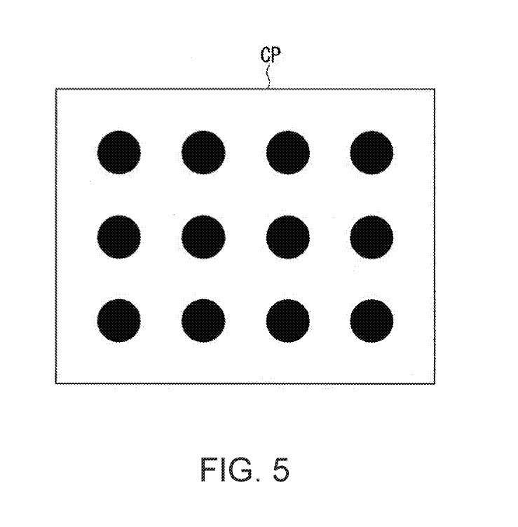

Here, FIG. 5 illustrates an example of the calibration plate disposed at the first position inside the work region. A plate CP illustrated in FIG. 5 is an example of the calibration plate. In this example, a plurality of dot patterns are drawn on the plate CP. Instead of the plurality of dot patterns, any pattern may be drawn in the plate CP as long as the pattern enables the calibration for associating the position on the image captured by the first imaging unit 21 and the position in the robot coordinate system RC with each other.

The robot control unit 363 reads imaging position/posture information stored in advance in the storage unit 32 from the storage unit 32. The imaging position/posture information indicates the above-described imaging position and imaging posture. The robot control unit 363 moves the first imaging unit 21 by operating the robot 20, and causes the position and the posture of the first imaging unit 21 to coincide with the imaging position and the imaging posture which are indicated by the read imaging position/posture information (Step S110). The robot control unit 363 may have a configuration in which the imaging posture is stored in advance. In this case, in Step S110, the robot control unit 363 reads the imaging position information stored in advance in the storage unit 32 from the storage unit 32. The imaging position information indicates the above-described imaging position. In this example, the position of the first imaging unit 21 is represented by the position in the robot coordinate system RC of the origin in the three-dimensional local coordinate system associated with the center of gravity of the first imaging unit 21. Alternatively, a configuration may be adopted in which the position of the first imaging unit 21 is represented by other positions associated with the first imaging unit 21. In this example, the posture of the first imaging unit 21 is represented by the direction in the robot coordinate system RC of each coordinate axis in the three-dimensional local coordinate system. Alternatively, a configuration may be adopted in which the posture of the first imaging unit 21 is represented by other directions associated with the first imaging unit 21.

Next, the imaging control unit 461 causes the first imaging unit 21 to image a range which can be imaged by the first imaging unit 21 (Step S120). Next, the image acquisition unit 463 acquires an image captured by the first imaging unit 21 from the first imaging unit 21 in Step S120 (Step S130).

Next, the calibration unit 465 performs the calibration for associating the position on the image and the position in the robot coordinate system RC with each other, based on the image acquired by the image acquisition unit 463 from the first imaging unit 21 in Step S130. In this case, the calibration unit 465 calculates the first distance which represents the distance between the first imaging unit 21 and the calibration plate (Step S140). For example, the distance between the first imaging unit 21 and the calibration plate represents the distance between the position of the center of gravity of the first imaging unit 21 and the position of the center of gravity of the calibration plate. Alternatively, the distance between the first imaging unit 21 and the calibration plate may the distance between any optional position associated with the first imaging unit 21 and any optional position associated with the calibration plate. The method by which the calibration unit 465 calculates the first distance may be a known method, or a method to be developed from now on.

Next, the calibration unit 465 generates the first distance information indicating the first distance calculated in Step S140. The calibration unit 465 stores the generated first distance information in the storage unit 32 (Step S150), and completes the process.

In the above-described calibration, the robot 20 and the calibration plate are often disposed so that the first distance is approximately 50 to 80 cm. However, the robot 20 and the calibration plate may be respectively disposed so that the first distance has a different length. Hereinafter, as an example, a case where the first distance is 70 cm will be described.

A configuration may be adopted in which the above-described calibration is performed multiple times. In this case, the robot control device 30 calculates the first distance as an average value of the distances calculated in Step S140 in each calibration.

In Step S140, the robot control device 30 operates the robot 20 in accordance with an operation received from a user, and a predetermined position of at least any one of the first end effector E1 and the second end effector E2 is brought into contact with the center of gravity of the calibration plate, thereby calculating the position of the center of gravity. In this manner, a configuration may be adopted in which the first distance is calculated based on the calculated position. In this case, the robot control device 30 performs the calibration in Step S140 by using the calculated first distance.

Instead of the configuration where the first position is calculated by performing the process in the flowchart illustrated in FIG. 4, a configuration may be adopted in which the robot control device 30 stores the position of the center of gravity of the calibration plate at the time of teaching such as direct teaching and online teaching, and in which the first position is be calculated based on the stored position. In this case, the robot control device 30 performs the calibration in Step S140 by using the calculated first distance.

The robot control device 30 may be configured to calculate or specify the first distance by using a method different from the above-described method. In this case, the robot control device 30 performs the calibration in Step S140 by using the calculated or specified first distance.

Process in which Robot Control Device Causes Robot to Carry Out Predetermined Work

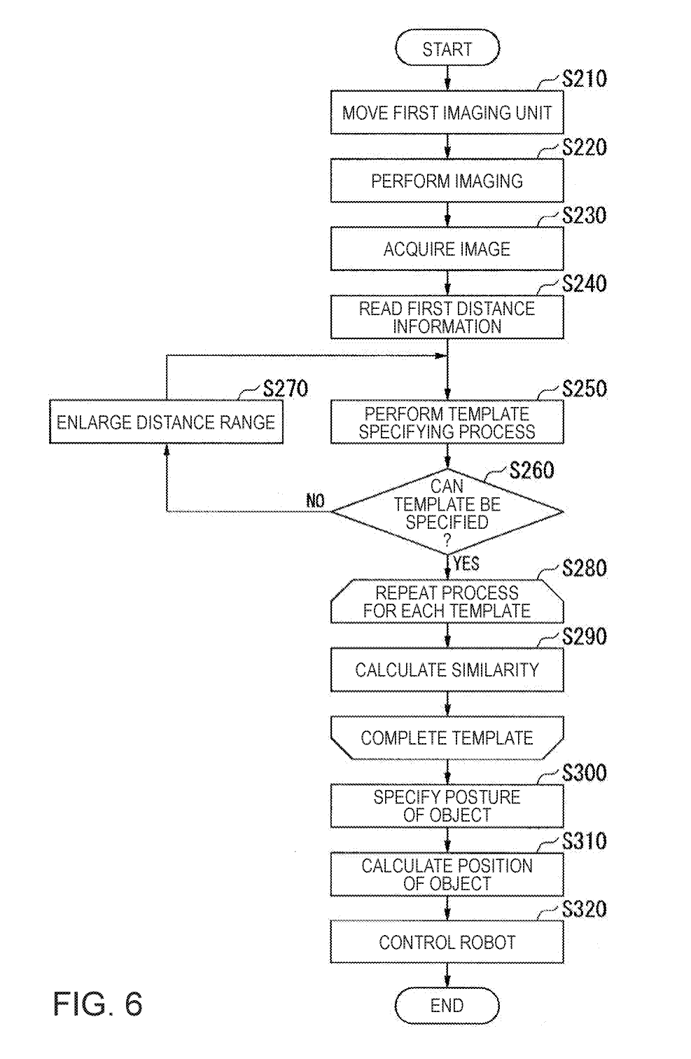

Hereinafter, referring to FIG. 6, the process in which the robot control device 30 causes the robot 20 to carry out the predetermined work will be described. FIG. 6 is a flowchart illustrating a flow in a process in which the robot control device 30 causes the robot 20 to carry out the predetermined work. In the following description, a process actively performed by each functional unit included in the image processing device 40 is performed by the image processing control unit 361 controlling each functional unit. Hereinafter, a case will be described where the above-described object O is previously disposed at the first position inside the work region.

The robot control unit 363 reads the imaging position/posture information stored in advance in the storage unit 32 from the storage unit 32. The robot control unit 363 moves the first imaging unit 21 by operating the robot 20, and causes the position and the posture of the first imaging unit 21 to coincide with the imaging position and the imaging posture which are indicated by the read imaging position/posture information (Step S210). A configuration may be adopted as follows. The robot control unit 363 does not read the imaging position/posture information from the storage unit 32 in Step S210, and causes the position and posture of the first imaging unit 21 to coincide with the imaging position and the imaging posture which are indicated by the imaging position/posture information read from the storage unit 32 in Step S110.

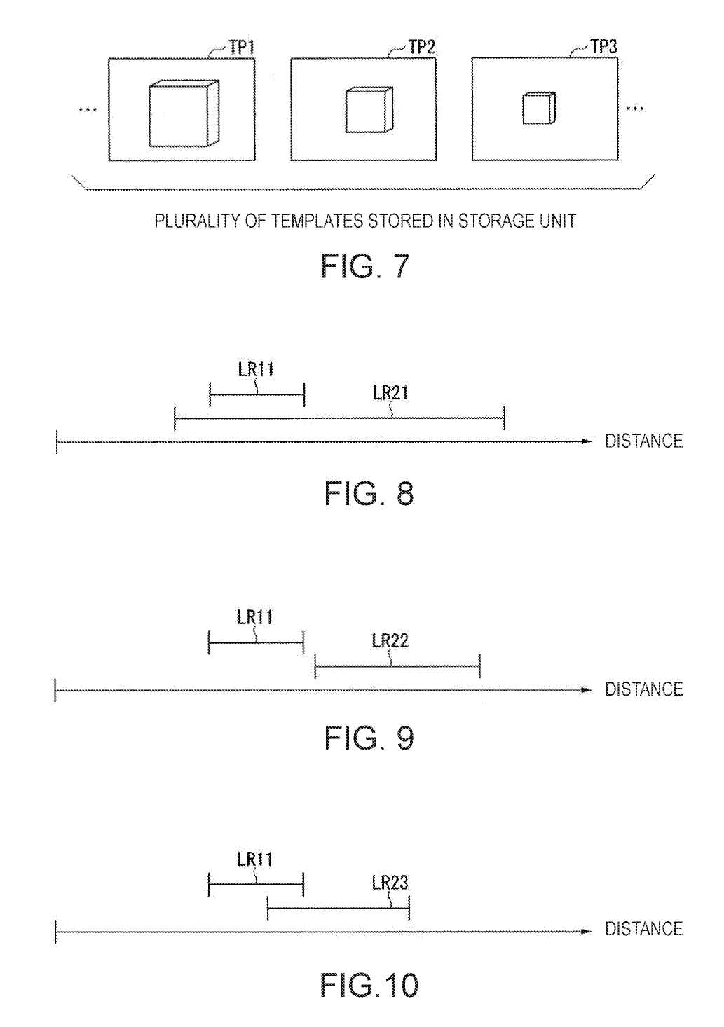

Next, the imaging control unit 461 causes the first imaging unit 21 to image a range which can be imaged by the first imaging unit 21 (Step S220). Next, the image acquisition unit 463 acquires an image captured by the first imaging unit 21 from the first imaging unit 21 in Step S220 (Step S230). Next, the template specifying unit 467 reads the first distance information stored in advance in the storage unit 32 from the storage unit 32 (Step S240). Next, the template specifying unit 467 performs a template specifying process of specifying one or more templates from among the plurality of the templates, based on the first distance information read in Step S240 (Step S250). Here, referring to FIGS. 7 to 10, the template specifying process in Step S250 will be described.

In this example, the plurality of templates are stored in advance in the storage unit 32 as illustrated in FIG. 7. FIG. 7 illustrates the plurality of templates stored in advance in the storage unit 32. Each of templates TP1 to TP3 illustrated in FIG. 7 is an example of three templates included in the plurality of templates stored in advance in the storage unit 32. As described above, a distance range corresponding to each template is associated with each template stored in the storage unit 32. More specifically, the distance range corresponding to a size (for example, an area) of the object O represented by each template is associated with each template. A median value of the distance range associated with each template decreases as the size of the object O represented by each template increases. The reason is as follows. When the object O is imaged, as the imaging unit which images the object O is closer to the object O, the size of the object O on the image captured by the imaging unit increases. The postures (that is, the above-described appearance) of the object O which are represented by the respective templates TP1 to TP3 illustrated in FIG. 7 are the same as each other. However, these are merely examples. It does not mean that all of the postures represented by the respective templates are the same as each other.

The template specifying unit 467 calculates a first distance range which represents a distance range in which the first distance is set as the median value, based on the first distance indicated by the first distance information read in Step S240. The first distance range means a range from a value obtained by subtracting a value obtained by multiplying the first distance by a first predetermined ratio from the first distance to a value obtained by adding a value obtained by multiplying the first distance by the first predetermined ratio to the first distance. In this example, the first predetermined ratio is 10%. Here, the first predetermined ratio may be a ratio representing a measurement error of the first distance, and may not be the ratio. Alternatively, the first predetermined ratio may be smaller than 10% or greater than 10%.

The template specifying unit 467 compares the calculated first distance range with the distance range associated with each template stored in the storage unit 32, specifies one or more templates associated with the distance range including the entire first distance range as one or more templates used for the template matching with the object O, and reads one or more specified templates from the storage unit 32. Here, FIG. 8 illustrates an example of a relationship between the distance range including the entire first distance range and the first distance range. A distance range LR11 illustrated in FIG. 8 is an example of the first distance range. A distance range LR21 is an example of the distance range associated with a certain template. In FIG. 8, the minimum value of the distance range LR21 is smaller than the minimum value of the distance range LR11. The maximum value of the distance range LR21 is greater than the maximum value of the distance range LR11. That is, the distance range LR21 represents the distance range which includes the entire distance range LR11. The template specifying unit 467 specifies one or more templates associated with the distance range including the entire first distance range in this way as one or more templates used for the template matching with the object O, and reads one or more specified templates from the storage unit 32.

FIG. 9 illustrates an example of a relationship between a distance range which does not include a portion of the first distance range and the first distance range. A distance range LR22 illustrated in FIG. 9 is another example of a distance range associated with a certain template. In FIG. 9, the minimum value of the distance range LR22 is greater than the maximum value of the distance range LR11. That is, the distance range LR22 does not include a portion of the distance range LR11. The template specifying unit 467 does not read one or more templates associated with the distance range which does not include a portion of the first distance range in this way, from the storage unit 32.

FIG. 10 illustrates an example of a relationship between a distance range which includes a portion of the first distance range and the first distance range. A distance range LR23 illustrated in FIG. 10 is yet another example of a distance range associated with a certain template. In FIG. 10, the minimum value of the distance range LR23 is smaller than the maximum value of the distance range LR11. The maximum value of the distance range LR23 is greater than the maximum value of the distance range LR11. That is, the distance range LR23 includes a portion of the distance range LR11. The template specifying unit 467 does not read one or more templates associated with the distance range including a portion of the first distance range in this way, from the storage unit 32. A configuration may be adopted as follows. The template specifying unit 467 specifies one or more templates associated with the distance range including a portion of the first distance range as one or more templates used for the template matching with the object O, and reads one or more of the specified templates from the storage unit 32.

A configuration may be adopted as follows. For example, in Step S250, the template specifying unit 467 uses a machine learning algorithm in which the first distance range is set as an input parameter, and specifies one or more templates similar to the template used for the template matching with the object O from among the plurality of templates stored in the storage unit 32.

After the template specifying process is performed in Step S250, the template specifying unit 467 determines whether or not one or more templates can be specified in Step S250 (Step S260). In a case where it is determined in Step S250 that one or more templates cannot be specified (NO in Step S260), the template specifying unit 467 changes the first distance information so that the distance range associated with each template stored in the storage unit 32 in Step S250 performed immediately before is enlarged in accordance with a second predetermined ratio (Step S270). For example, the second predetermined ratio is 10%. The second predetermined ratio may be smaller than 10%, or may be greater than 10%. The template specifying unit 467 proceeds to Step S250, and performs the template specifying process again. On the other hand, in a case where the template specifying unit 467 determines that one or more templates can be specified in Step S250 (Step YES in S260), the position/posture calculation unit 469 repeatedly performs the process in Step S290 for every one or more templates read in Step S250 (Step S280).

The position/posture calculation unit 469 performs the template matching using the template selected in Step S280 and the image acquired by the image acquisition unit 463 in Step S230, and calculates similarity which represents a degree of similarity between the template and the image (Step S290). The position/posture calculation unit 469 associates the calculated the similarity with the template. A method of calculating the similarity by performing the template matching in Step S290 may be a known method, or a method to be developed from now on.

After the process in Step S290 is repeatedly performed for everyone or more templates read from the storage unit 32 in Step S250, the position/posture calculation unit 469 specifies the template associated with the closest similarity calculated in the repeated processes in Step S280 to Step S290. The position/posture calculation unit 469 specifies the posture associated with the specified template as the posture of the object O (Step S300).

Next, the position/posture calculation unit 469 calculates the position of the object O, based on the image acquired by the image acquisition unit 463 in Step S230 (Step S310). More specifically, the position/posture calculation unit 469 detects the center of gravity of the object O from the image by performing pattern matching. The position/posture calculation unit 469 converts the position on the image which is the position of the detected center of gravity into the position in the robot coordinate system RC. The position represents the position of the object O which is calculated by the position/posture calculation unit 469.

Next, the robot control unit 363 causes the robot 20 to carry out the predetermined work, based on the position and the posture of the object O which are calculated by the position/posture calculation unit 469 (Step S320).

A configuration may be adopted as follows. Ina case where the range which can be imaged by the first imaging unit 21 includes two or more objects having mutually different distances from the first imaging unit 21, the robot control device 30 performs the processes in flowcharts illustrated in FIGS. 4 and 6 for each region including each of the two or more objects within the plurality of regions into which one image captured by the first imaging unit 21 is divided. That is, the robot control device 30 divides one image into the plurality of regions, and specifies the template for each of the plurality of regions, based on the first distance information obtained for each of the plurality of divided regions. In this manner, based on the first distance information obtained for each of the plurality of regions into which one image obtained by causing the first imaging unit 21 to image the object disposed inside the work region is divided, the robot control device 30 can reduce the work to be carried out by the user in order to perform the matching between the template and the image obtained by imaging the object.

### Modification Example of Embodiment

Hereinafter, a modification example of the embodiment will be described. In the modification example of the embodiment, instead of a configuration in which the above-described distance range is associated with each template, the distance range is associated with each of a plurality of scale factors which enlarges or reduces the template. In the modification example, the storage unit 32 stores one template corresponding to the posture of the object O for each posture of the object O. For example, in a case where the object O has the N-number of postures (N is an integer equal to or greater than 1), the storage unit 32 stores the N-number of templates corresponding to the respective postures. That is, in Step S250 illustrated in FIG. 6, the template specifying unit 467 specifies one or more scale factors associated with the distance range which includes all of the first distance range.

In Step S260, the template specifying unit 467 determines whether or not one or more scale factors can be specified in Step S250. In a case where the template specifying unit 467 determines in Step S260 that one or more scale factors can be specified in Step S250, in Step S280, the position/posture calculation unit 469 performs the processes in Step S280 to Step S290 for every one or more scale factors specified in Step S250. For example, after the position/posture calculation unit 469 selects a certain scale factor, the position/posture calculation unit 469 uses the selected scale factor so as to enlarge or reduce all of the plurality of the templates (templates associated with the respective postures of the object O) stored in the storage unit 32. The position/posture calculation unit 469 repeatedly performs the process in Step S290 for each enlarged or reduced template. In this manner, based on the first distance information and the distance range associated with the scale factor of the template, the robot control device 30 can reduce the work to be carried out by the user in order to perform the template matching between the template and the image obtained by imaging the object O.

The above-described image processing device 40 may be separate from the robot control device 30. In this case, the image processing device 40 is connected to the robot control device 30 so as to be capable of communicating with the robot control device 30 wirelessly or in a wired manner. In this case, the image processing device 40 includes a hardware functional unit such as the CPU, the storage unit, and the communication unit.

As described above, the image processing device 40 specifies the template, based on the first distance information obtained by causing the imaging unit (in the above-described example, the first imaging unit 21) to image the calibration plate disposed at the first position inside the work region where the robot 20 carries out the work, and performs the matching (in the above-described example, the template matching) between the specified template and the image obtained by causing the imaging unit to image the object disposed inside the work region. In this manner, the image processing device 40 can reduce the work to be carried out by the user in order to perform the matching between the template and the image obtained by imaging the object (in the above-described example, the object O).

The image processing device 40 specifies the template, based on the first distance information indicating the distance between the calibration plate and the imaging unit, which is the distance calculated based on the image obtained by causing the imaging unit to image the calibration plate during the calibration. In this manner, the image processing device 40 can reduce the work to be carried out by the user in order to perform the matching between the template and the image obtained by imaging the object, based on the first distance information.

The image processing device 40 specifies the template, based on the first distance information obtained by causing the imaging unit to image the calibration plate disposed at the first position inside the work region where the robot 20 carries out the work, and performs the matching between the specified template and the two-dimensional image obtained by causing the imaging unit to image the object disposed inside the work region. In this manner, the image processing device 40 can reduce the work to be carried out by the user in order to perform the matching between the template and the two-dimensional image captured by imaging the object.

When the image processing device 40 obtains the first distance information, the calibration plate is disposed at the first position inside the work region. When the image processing device 40 performs the matching between the template and the image obtained by causing the imaging unit to image the object disposed inside the work region, the object is disposed within the predetermined range including the first position inside the work region. In this manner, the image processing device 40 can reduce the work to be carried out by the user in order to perform the matching between the template and the image obtained by imaging the object, based on the calibration plate disposed at the first position inside the work region and the object disposed within the predetermined range including the first position inside the work region.

In the image processing device 40, when the matching is performed between the template and the image obtained by causing the imaging unit to image the object disposed inside the work region, the object is disposed at the first position inside the work region. In this manner, the image processing device 40 can reduce the work to be carried out by the user in order to perform the matching between the template and the image obtained by imaging the object, based on the calibration plate disposed at the first position inside the work region and the object disposed at the first position inside the work region.

The image processing device 40 specifies the template, based on the first distance information obtained by causing the imaging unit to image the calibration plate disposed at the first position inside the work region where the robot 20 including the imaging unit carries out the work, and performs the matching between the specified template and the image obtained by causing the imaging unit to image the object disposed inside the work region. In this manner, the image processing device 40 can reduce the work to be carried out by the user in order to perform the matching between the template and the image obtained by causing the imaging unit included in the robot 20 to image the object.

The image processing device 40 specifies the template, based on the first distance information obtained by causing the imaging unit to image the calibration plate disposed at the first position inside the work region where the robot 20 including the imaging unit carries out the work, at the imaging position indicated by the imaging position information, and performs the matching between the specified template and the image obtained by causing the imaging unit to image the object disposed inside the work region, at the imaging position indicated by the imaging position information. In this manner, the image processing device 40 can reduce the work to be carried out by the user in order to perform the matching between the template and the image obtained by causing the imaging unit included in the robot 20 to image the object at the imaging position indicated by the imaging position information.

The image processing device 40 specifies the template, based on the first distance information and the distance range associated with the template. Alternatively, the image processing device 40 specifies the template, based on the first distance information and the distance range associated with the scale factor of the template. In this manner, the image processing device 40 can reduce the work to be carried out by the user in order to perform the matching between the template and the image obtained by imaging the object, based on the first distance information and the distance range associated with the template, or based on the first distance information and the distance range associated with the scale factor of the template.

The image processing device 40 divides one image obtained by causing the imaging unit to image the object disposed inside the work region into the plurality of regions, and specifies the template for each of the plurality of regions, based on the first distance information obtained for each of the plurality of divided regions. In this manner, the image processing device 40 can reduce the work to be carried out by the user in order to perform the matching between the template and the image obtained by imaging the object, based on the first distance information obtained for each of the plurality of regions into which one image obtained by causing the imaging unit to image the object disposed inside the work region is divided.

The robot control device 30 operates the robot 20, based on the result of the matching performed by the image processing device 40. In this manner, the robot control device 30 can reduce the work to be carried out by the user in order to cause the robot 20 to carry out the work.

The robot 20 carries out the work for the object, based on the result of the matching performed by the image processing device 40. In this manner, the robot 20 can reduce the work to be carried out by the user in order to cause the robot 20 to carry out the work.

Hitherto, the embodiment according to the invention has been described in detail with reference to the drawings. However, a specific configuration is not limited to the embodiment. Various modifications, substitutions, or deletions may be made without departing from the gist of the invention.

A program for realizing a function of any desired functional unit in the above-described device (for example, the image processing device 40 and the robot control device 30) may be recorded in a computer-readable recording medium, and the program may be incorporated into and executed by a computer system. The “computer system” described herein includes an operating system (OS) and hardware such as peripheral devices. The “computer-readable recording medium” means a portable medium such as a flexible disk, a magneto-optical disk, as a ROM, a compact disk (CD)-ROM, and a storage medium such as a hard disk incorporated in the computer system. Furthermore, the “computer-readable recording medium” means those which holds a program for a certain period of time, such as a volatile memory (RAM) inside the computer system serving as a server or a client in a case where the program is transmitted via a network such as the Internet or a communication line such as a telephone line.

The above-described program may be transmitted from a computer system having a program stored in a storage device to another computer system via a transmission medium or by a transmission wave in a transmission medium. Here, the “transmission medium” for transmitting the program means a medium having an information transmitting function as in the network (communication network) such as the Internet and the communication line (communication cable) such as the telephone line.

The above-described program may partially realize the above-described functions. Furthermore, the above-described program may be a so-called differential file (differential program) which can realize the above-described functions in combination with a program previously recorded in the computer system.

The entire disclosure of Japanese Patent Application No. 2017-015147, filed Jan. 31, 2017 is expressly incorporated by reference herein.

What is claimed is:

1. An image processing device comprising:
a processor,
wherein the processor specifies a template, based on first distance information obtained by causing an imaging unit to image a calibration plate disposed at a first position inside a work region where a robot carries out work, and performs matching between the specified template and an image obtained by causing the imaging unit to image an object disposed inside the work region.

2. The image processing device according to claim 1,
wherein the processor specifies the template, based on the first distance information indicating a distance between the calibration plate and the imaging unit, which is a distance calculated based on the image obtained by causing the imaging unit to image the calibration plate during calibration.

3. The image processing device according to claim 1,
wherein the image captured by the imaging unit is a two-dimensional image.

4. The image processing device according to claim 1,
wherein when the first distance information is obtained, the calibration plate is disposed at the first position, and
wherein when the matching is performed, the object is disposed within a predetermined range including the first position inside the work region.

5. The image processing device according to claim 4,
wherein when the matching is performed, the object is disposed at the first position.

6. The image processing device according to claim 1,
wherein the robot includes the imaging unit.

7. The image processing device according to claim 6,
wherein imaging position information indicating an imaging position where the image is captured by the imaging unit is stored in advance in a robot control device which controls the robot.

8. The image processing device according to claim 1,
wherein the processor specifies the template, based on a distance range associated with the first distance information and the template, or specifies the template, based on a distance range associated with the first distance information and a scale factor of the template.

9. The image processing device according to claim 1,
wherein the processor divides one of the images into a plurality of regions, and specifies the template for each of the plurality of regions, based on the first distance information obtained for each of the plurality of divided regions.

10. A robot control device comprising:
the image processing device according to claim 1,
wherein the robot is operated based on a result of the matching performed by the image processing device.

11. A robot control device comprising:
the image processing device according to claim 2,
wherein the robot is operated based on a result of the matching performed by the image processing device.

12. A robot control device comprising:
the image processing device according to claim 3,
wherein the robot is operated based on a result of the matching performed by the image processing device.

13. A robot control device comprising:
the image processing device according to claim 4,
wherein the robot is operated based on a result of the matching performed by the image processing device.

14. A robot control device comprising:
the image processing device according to claim 5,
wherein the robot is operated based on a result of the matching performed by the image processing device.

15. A robot controlled by the robot control device according to claim 10.

16. A robot controlled by the robot control device according to claim 11.

17. A robot controlled by the robot control device according to claim 12.

18. A robot controlled by the robot control device according to claim 13.

19. A robot controlled by the robot control device according to claim 14.
